(19) United States
(12) Patent Application Publication
(10) Pub. No.: US 2022/0379939 A1
(43) Pub. Date: Dec. 1, 2022

(54) COLLAPSIBLE STORAGE

(71) Applicants: Anthony V. Codispoti, Columbus, OH (US); Anthony Codispoti, Columbus, OH (US)

(72) Inventors: Anthony V. Codispoti, Columbus, OH (US); Anthony Codispoti, Columbus, OH (US)

(21) Appl. No.: 17/862,012

(22) Filed: Jul. 11, 2022

Related U.S. Application Data
(63) Continuation-in-part of application No. 17/830,086, filed on Jun. 1, 2022.
(60) Provisional application No. 63/195,381, filed on Jun. 1, 2021.

(51) Int. Cl. B62B 3/02; B65D 21/08; B65D 25/06; B65D 25/28; B62B 3/00

(52) U.S. Cl. CPC B62B 3/02; B65D 21/086; B65D 25/06; B65D 25/2808; B62B 3/005

(57) ABSTRACT

A collapsible storage unit can include one or more columns of storage chambers, each having one or more storage regions that can change height from a collapsed configuration to an extended configuration. The storage chambers can open and closed manually, or with various mechanisms, such as scissor lifts, hydraulics, springs, linear actuators, motors and the like.

### CROSS-REFERENCE TO RELATED APPLICATIONS

This Application is a continuation-in-part of U.S. patent application Ser. No. 17/830,086, filed Jun. 1, 2022, which claims the benefit of priority of U.S. provisional patent application No. 63/195,381, filed Jun. 1, 2021, the contents of which are herein incorporated by reference.

### BACKGROUND OF THE INVENTION

### 1. Field of the Invention

Embodiments of the invention relate generally to storage devices. More particularly, embodiments of the invention relate to a folding or collapsible storage unit that expands for better accessibility and visibility.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Storage units include chests or drawers. Storage chests typically open with a hinged top to provide access to an interior region. Typically, this interior is a single, large space, requiring a user to stack smaller items to take advantage of the interior storage height. Drawers can provide more shallow storage, for example, multiple storage chambers in the same storage height as a storage chest. This can be useful for smaller items. Drawers, however, open outward, providing access at the height of the drawer itself. Further, drawers have open tops, as top access is the method of getting items in and out of the drawers. And most drawers do not completely slide out, so items in the back of the drawers are more difficult to see and access.

In view of the foregoing, there is a need for an improved storage device that can provide a storage region that can have a closed height and a different open height.

### SUMMARY OF THE INVENTION

Embodiments of the present invention provide a collapsible storage system comprising a plurality of compartments, each having a base, opposing sides rising from the base, a back member rising from the base and interconnecting the opposing sides at a back end thereof, a front member rising from the base and interconnecting the opposing sides at a front end thereof and an open top; and a lift mechanism for raising at least one of the plurality of compartments away from a respective one of the plurality of compartments located immediately below, wherein the collapsible storage system is movable between a closed configuration, where the base of an upper one of the plurality of compartments covers the open top of an immediately lower one of the plurality of compartments, and an open configuration, where access to the open top of each of the compartments is provided.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a collapsible storage system with a scissor type attachment in a closed configuration, according to an exemplary embodiment of the present invention;

FIG. 2 illustrates a perspective view of the collapsible storage system of FIG. 1 in an open configuration;

FIG. 3 illustrates a collapsible storage system with telescoping lifts in a closed configuration, according to an exemplary embodiment of the present invention;

FIG. 4 illustrates the collapsible storage system of FIG. 3 in an open configuration;

FIG. 5 illustrates a collapsible storage system with a linear actuator that may be operated with a motor or through a variety of manual methods, in an open configuration, according to an exemplary embodiment of the present invention;

FIG. 6 illustrates a collapsible storage system with a spring or hydraulic lift, in an open configuration, according to an exemplary embodiment of the present invention;

FIG. 7 illustrates a collapsible storage system with a spring or hydraulic lift, in an open configuration, according to an exemplary embodiment of the present invention;

FIG. 8 illustrates a collapsible storage system with a scissor type lift with hydraulics and stabilizer bars on the sides, in an open configuration, according to an exemplary embodiment of the present invention;

FIG. 9 illustrates a collapsible storage system with a luggage handle-style telescoping member, in a closed configuration, according to an exemplary embodiment of the present invention;

FIG. 10 illustrates the collapsible storage system of FIG. 9 in an open configuration;

FIG. 11 illustrates a collapsible storage system, in a closed configuration, used in a desktop environment, according to an exemplary embodiment of the present invention;

FIG. 12 illustrates the collapsible storage system of FIG. 11 in an open configuration;

FIG. 13 illustrates a collapsible storage system, in a closed configuration, used in an under-desk environment, according to an exemplary embodiment of the present invention;

FIG. 14 illustrates the collapsible storage system of FIG. 13 in an open configuration;

FIG. 15 illustrates a collapsible storage system, in a closed configuration, used in a closet environment, according to an exemplary embodiment of the present invention;

FIG. 16 illustrates the collapsible storage system of FIG. 15 in an open configuration;

FIG. 17 illustrates a collapsible storage system, in a closed configuration, used on a tool bench top environment, according to an exemplary embodiment of the present invention;

FIG. 18 illustrates the collapsible storage system of FIG. 17 in an open configuration;

FIG. 19 illustrate a collapsible storage system, usable in a dropdown expansion mode, in a closed configuration, used in a kitchen environment, according to an exemplary embodiment of the present invention;

FIG. 20 illustrates the collapsible storage system of FIG. 19 in an open configuration;

FIG. 21 illustrates a collapsible storage system, usable in a dropdown expansion mode, in an open configuration, having slides for each compartment, according to an exemplary embodiment of the present invention;

FIG. 22 illustrates a collapsible storage system, in an open configuration, using scissor type lift with hydraulic or spring assist, according to an exemplary embodiment of the present invention;

FIG. 23 illustrates a detailed view of the top compartment and part of the middle compartment of the collapsible storage system of FIG. 22;

FIG. 24 illustrates a detailed side view of the middle compartment and part of the top compartment of the collapsible storage system of FIG. 22; and

FIG. 25 illustrates a detailed side view of the lower compartment and part of the middle compartment of the collapsible storage system of FIG. 22.

Unless otherwise indicated illustrations in the figures are not necessarily drawn to scale. The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a collapsible storage unit that can include one or more columns of storage chambers, each having one or more storage regions that can change height from a collapsed configuration to an extended configuration.

As discussed in greater detail below, in some embodiments, the collapsible storage unit can include a scissor hinge on the sides and/or back that allows the storage bins to easily telescope up, providing a user with easy access to items stored in bins underneath. The collapsible storage unit can easily telescope down to a fully compacted, space-saving position.

In some embodiments, the scissor hinge can be disposed on the bottom of the lowest storage bin. In this embodiment, a pivoting front panel can be provided to allow easy access to the storage bins.

The hinges may be spring loaded or pneumatic or hydraulic assisted to allow for easy up/down movement.

In some embodiments, a side slide member may be used in place of the scissor hinges. The side slide members can be, for example, similar to horizontal drawer slides, but operating vertically. The result would be similar to the scissor hinges, allowing the storage bins, stacked together in the collapsed configuration, to be raised apart in an extended configuration. The slides may, like the hinges, be spring loaded or pneumatic or hydraulic assisted to allow for easy up/down movement.

In some embodiments, the shelves will lock into place at the fully extended position and the fully compacted position for safety. Various locking mechanisms may be used, depending on the intended use of the storage units.

As described in greater detail below, the storage bins may be used in various environments, including closets, offices, workbenches, kitchen, or could even be encased in a chest or piece of furniture. In some embodiments, the storage bins may be disposed on a wheeled base. In some embodiments the storage bins may be built into finished furniture i.e., coffee tables, night stands, chairs, beds, tables and the like.

The storage unit could be a stand alone shelving unit that can be placed in closet, for example, or could be attached to a wall, or the like. In some embodiments, in addition to the collapsible storage bin(s), the storage unit could include other conventional features, such as one or more drawers, one or more cabinets, storage cubbies, or the like.

In some embodiments, a back brace can be included. The back brace could be useful, for example, a mounting bracket or to give extra stability to the storage unit.

In some embodiments, the storage bins may be electronically assisted for raising or lowering, where a motor or other type of linear actuator can be provided to move the scissor hinge, or to lift the bins along the sliding/telescopic side arms, or the like. In some embodiments, the motor could drive a pneumatic or hydraulic pump that can use air for extending and collapsing the storage bins. Buttons may be provided to activate the motor, or a remote control may be used for extending and collapsing the storage bins.

Of course, other mechanisms, as may be known in the art, may be used to lift and/or separate the storage bins stacked in one column.

While each storage column is shown as being independently operable, in some embodiments, all the storage columns may extend and collapse together.

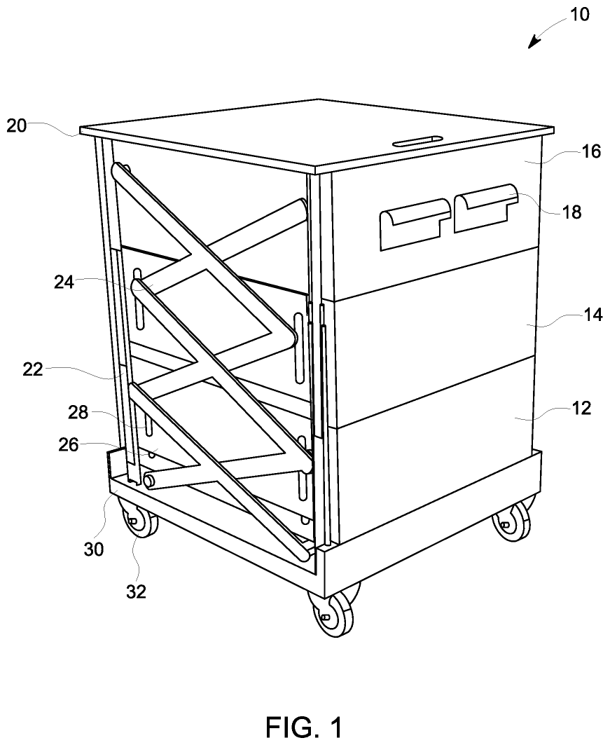

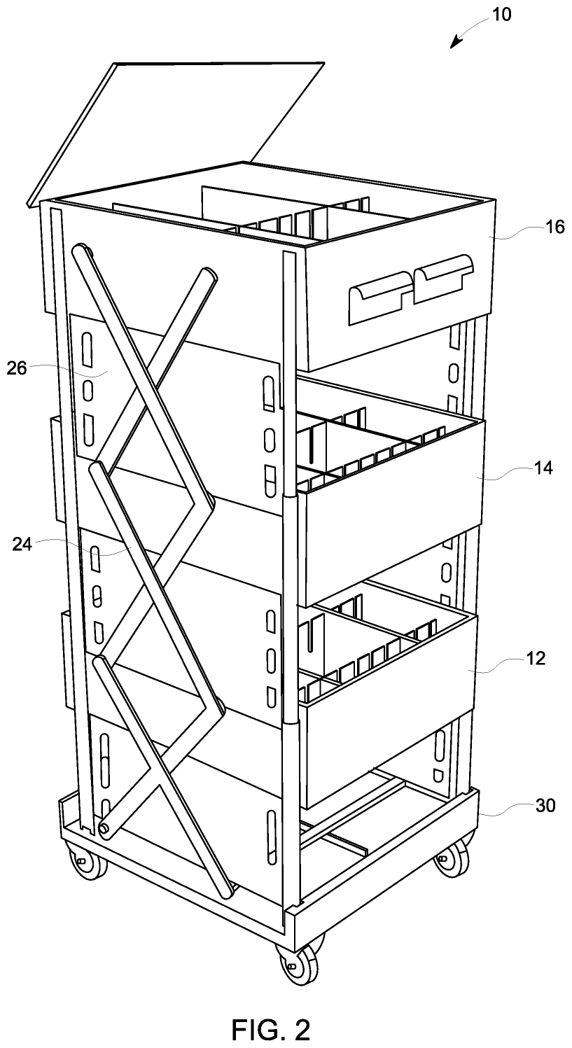

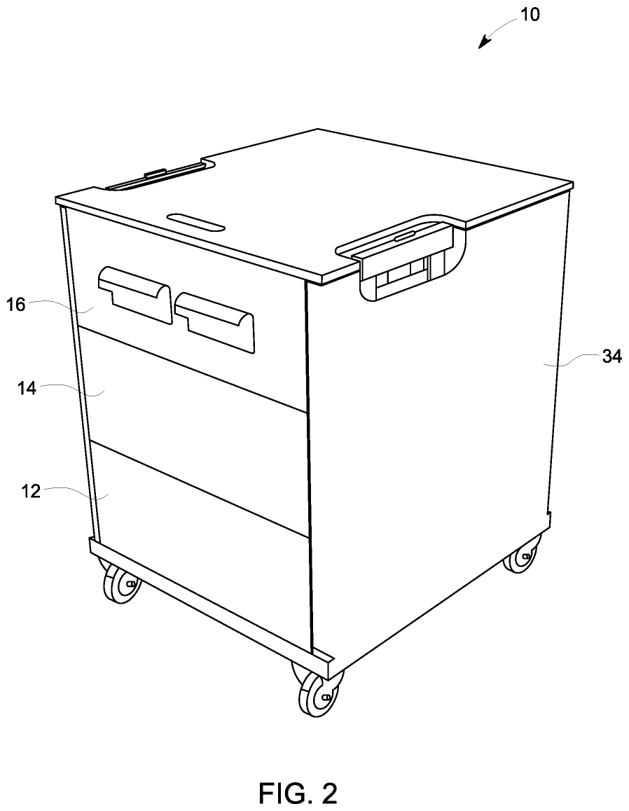

Referring now to FIGS. 1 and 2, a collapsible storage system 10 (also referred to simply as system 10) can include a bottom compartment 12, a middle compartment 14 and a top compartment 16. The compartments may be closed, as shown in FIG. 1, where the top of the bottom compartment 12 contacts the bottom of the middle compartment 14, and the top of the middle compartment 14 contacts the bottom of the top compartment 16. Various lift mechanisms, such as a scissor lift 24 may be used to raise the compartments to form a space between each of the compartments, allowing access to the inside of the compartments from the open top of each compartment. Handles 18 may be provided on one or more of the compartments to help lift and/or lower the compartments to and from the open configuration. Each compartment may have an open top, and in some embodiments, a top cover 20 may be provided on the top compartment 16. The top cover 20 may simply rest on the top compartment 16, allowing complete removal thereof, or may be hingably or slidably connected to the top compartment 16. In either case, the top cover 20 may be moved to permit access to the top compartment 16 through its open top. While three compartments are shown, it should be understood that, in this embodiment, and in each embodiment described herein, any number of compartments may be provided. In some embodiments, the top cover may be omitted.

Braces 22 may be provided to connect the compartments along outer surfaces thereof. Typically, the braces 22 may be telescoping members that are provided on at least opposing sides of the system 10. In some embodiments, the braces 22 may be provided at each corner of the system 10, as shown. In some embodiments, the braces 22 may simply provide vertical support and may extend vertically with the extension axis of the braces 22 being parallel with a direction of movement of the compartments when moving between open and closed configurations. In some embodiments, the braces 22 may be simple telescoping members. In other embodiments, the braces 22 may include additional features, such as internal springs for assisting in raising or lowering the compartments or may include catches for helping secure the system 10 in open configurations or closed configurations.

In some embodiments, inside panels 26 can be provided to protect users from fingers being pinched during opening/closing, for example. Panel slots 28 can permit the inside panels 26 to move from being along side the compartments when the system 10 is in the closed configuration, to being disposed in the open spaces between the compartments when in the open configuration, as shown in FIG. 2. The inside panels 26 may be provided on any of the embodiments described herein, where such features are shown in some of the subsequent figures and are not shown in others. The absence of an illustration of the inside panels 26 does not preclude the use of such a panel.

In some embodiments, the system 10 can be disposed on a base 30 that may include a plurality of wheels 32 to permit movement thereof. Of course, the wheels 32 may be removed where a permanent placement of the system 10 is desired.

In some embodiments, outside walls 34 may be provided to cover the lift mechanisms. Such outside walls 34 may improve the aesthetics of the device and may also provide safety by preventing direct access to the lift mechanism and other moving parts. The outside walls 34, like the inside panels 26, may be provided on various embodiments, whether or not such outside walls are shown in the respective figures.

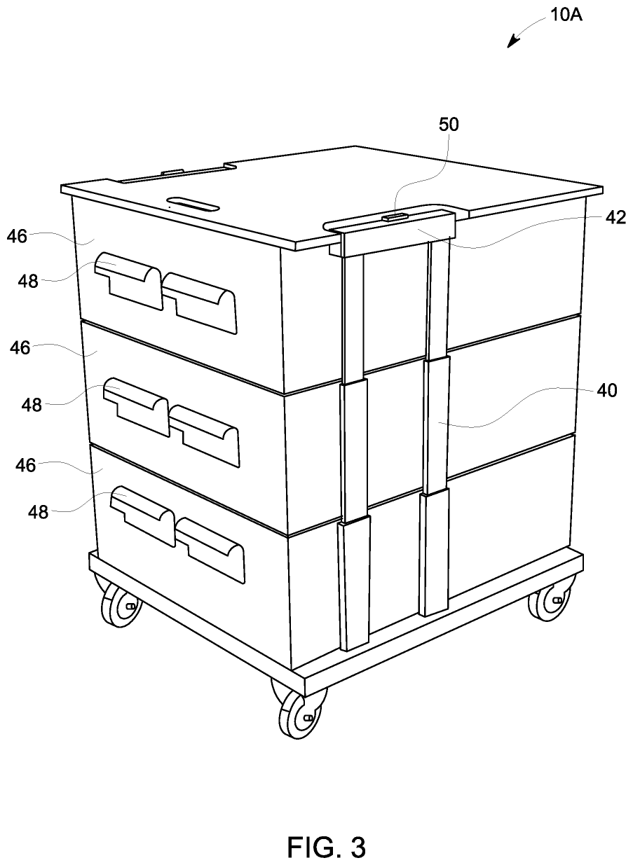

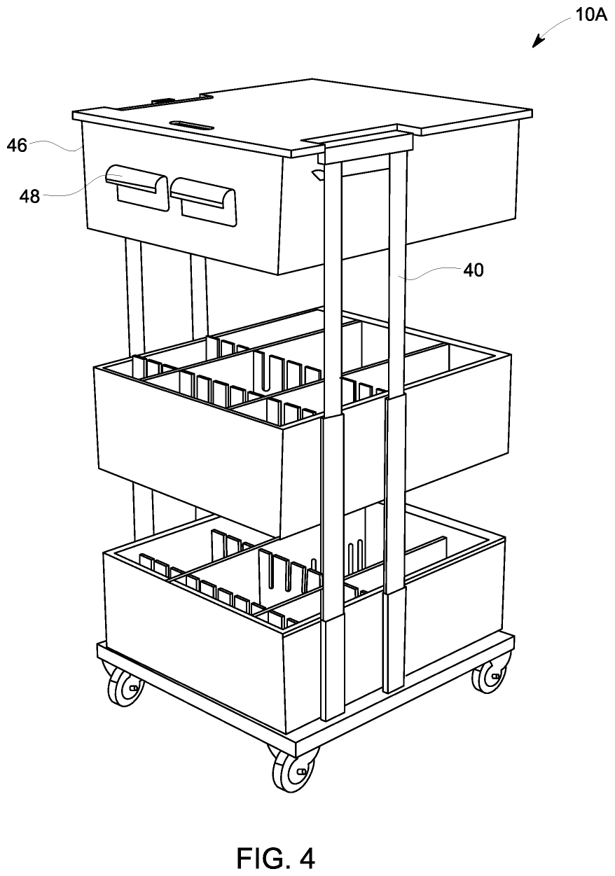

Referring to FIGS. 3 and 4, a telescoping lift type collapsible storage system 10A can include a telescoping lift 40 with a handle 42 to permit raising and lowering the system between open and closed configurations. A release button 50 can be provided to permit movement between the open and closed configurations of the compartments 46. Handles 48 may be provided on each compartment 46 to help lifting the system 10A or to also permit access into the compartments 46 when the front faces are hinged to permit front access into the compartments 46, as shown in various examples below.

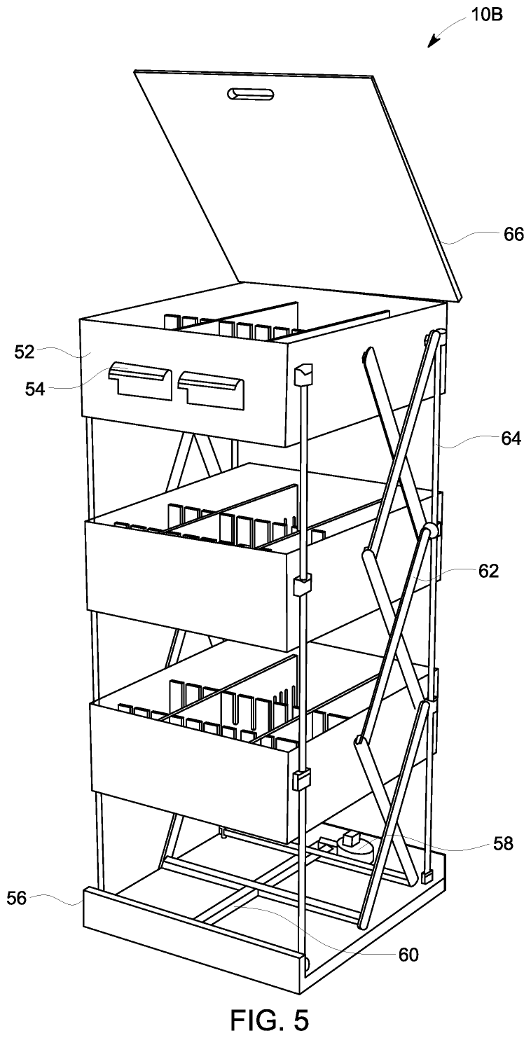

Referring to FIG. 5, a linear actuator or motor lift type collapsible storage system 10B is shown where the compartments 52 can move between the open and closed configurations via a linear actuator or motor 58. In some embodiments, the linear actuator or motor 58 can drive a driven arm 60 to cause the scissor lift 62 to actuate. Like other embodiments, the system 10B can include a top cover 66 and telescoping braces 64, as described above. In some embodiments, the linear actuator or motor 58 may be disposed within a base 56 of the system 10B, as shown.

Referring to FIG. 6, a hydraulic-assisted collapsible storage system 10C includes a hydraulic lift 68 disposed to help move the scissor type mechanism 72 as shown. The hydraulic lift 68 may provide a pushing force to help raise the system 10C into the open configuration. Typically, one hydraulic lift 68 may be disposed on each side of the base member to help move the scissor type mechanism 72. In other embodiments, the hydraulic lift or spring may be located in the back. The force provided by the hydraulic lift may vary depending on use and function. Typically, the hydraulic lift 68 can provide a force sufficient to help lift the compartments. In some embodiments, the hydraulic lift 68 can provide enough force to automatically open the system 10C and hold the system 10C in the open configuration, where a user applied force can move the system 10C into the closed configuration. In this embodiment, a locking mechanism can hold the system 10C in the closed configuration.

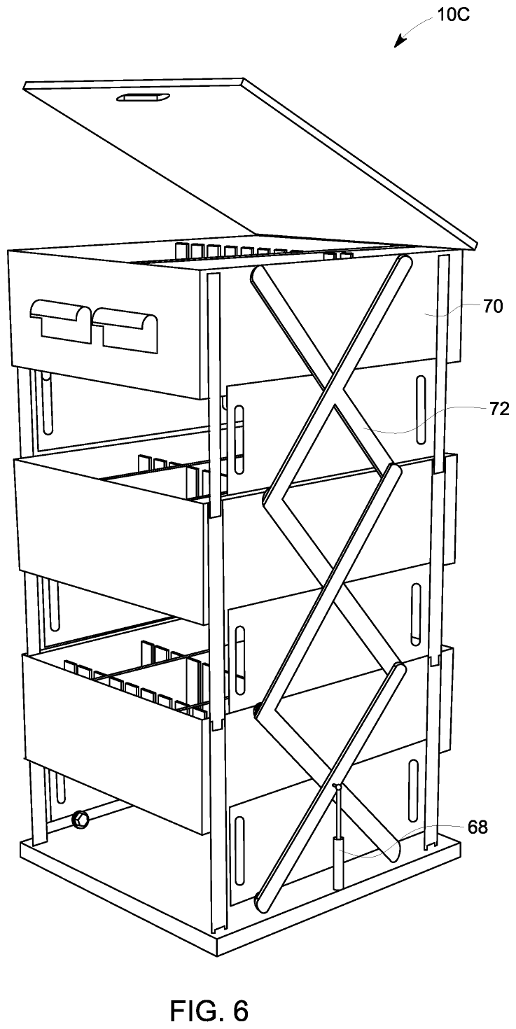

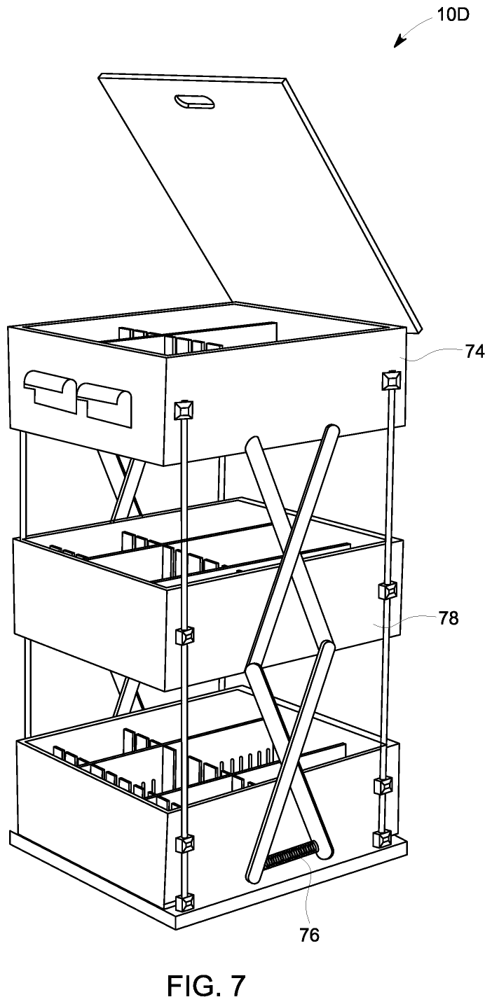

Referring to FIG. 7, a collapsible storage system 10D can use a scissor type mechanism 80 for moving the compartments between the open and closed configurations. Channels may be formed in the sides of each of the compartments where the scissors interact with the compartments and slide therein during opening and closing of the system 10D. The channels can include an upper channel 74 in the upper compartment, a lower channel 76 in the lower compartment and a middle channel 78 in the middle compartment. Inside the channels, one or more of a spring, pneumatic cylinder, hydraulic cylinder or the like may provide forces to the scissors 80 to help in opening the system 10D. For example, the springs or cylinders may provide a force that lifts, at a controlled rate, the system 10D from the closed configuration into the open configuration when a lock mechanism (not shown) is released. For example, a user may press a release button (similar to those described herein with respect to other embodiments) that releases a catch that would otherwise hold the system 10D in the closed configuration. Once released, the system 10D can open by the force of the springs, pneumatic cylinders and/or hydraulic cylinders.

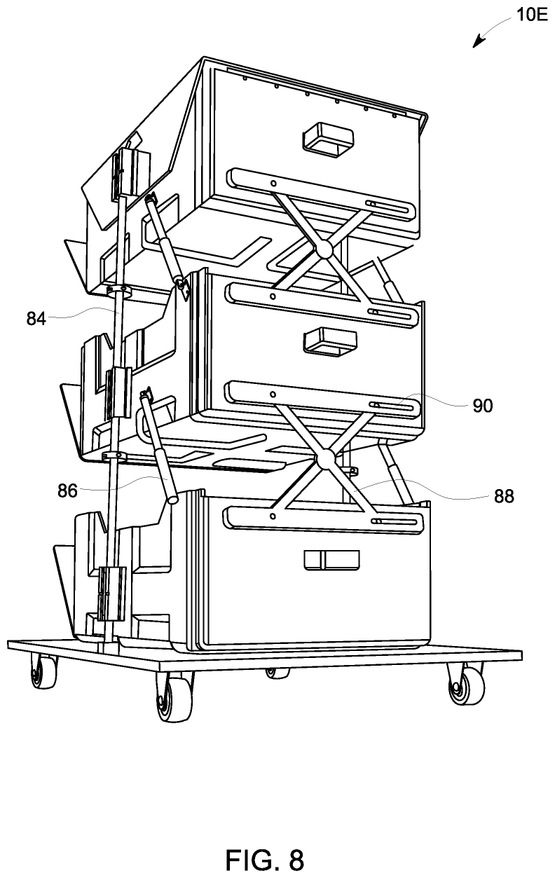

Referring now to FIG. 8, another example of a collapsible storage system 10E is shown. In this embodiment, a single scissor 88 interacting in channels 90 of the compartments is used along with a telescoping member 84 and a plurality of hydraulic or pneumatic cylinders 86. This embodiment illustrates that the scissors may be disposed on various sides of the compartments, such as a single side, as shown, opposing sides, as shown above, solely on the back, or in three or four sides of the system. Further, the channels 90 may house springs, pneumatic cylinders, hydraulic cylinders, or the like, to further assist in movement of the compartments between the open and closed configurations.

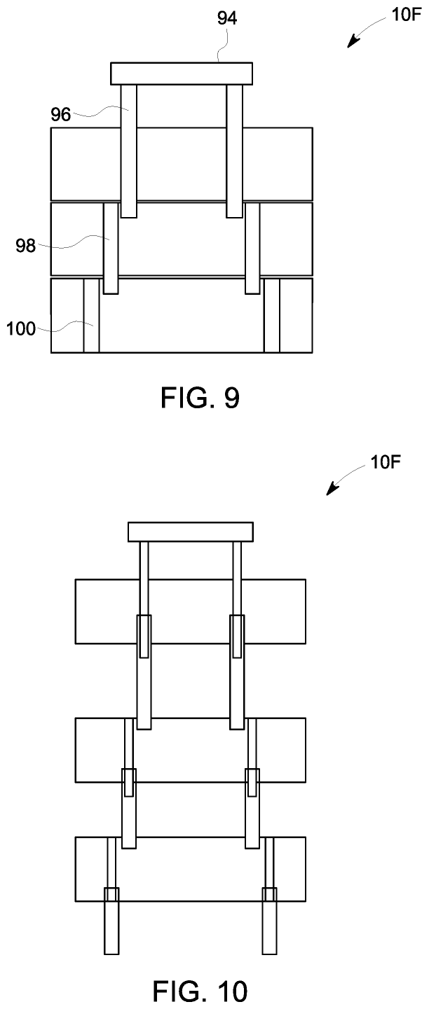

Referring to FIGS. 9 and 10, a collapsible storage system 1OF can include separate telescoping members 96, 98, 100 to join the compartments. A handle 94 may be disposed at the end of the upper telescoping members 96 to help raise the upper compartment. In this embodiment, a user may raise only the upper compartment, or raise the upper and middle compartments. Each interconnection between compartments may be made by telescoping members that are not aligned with the others.

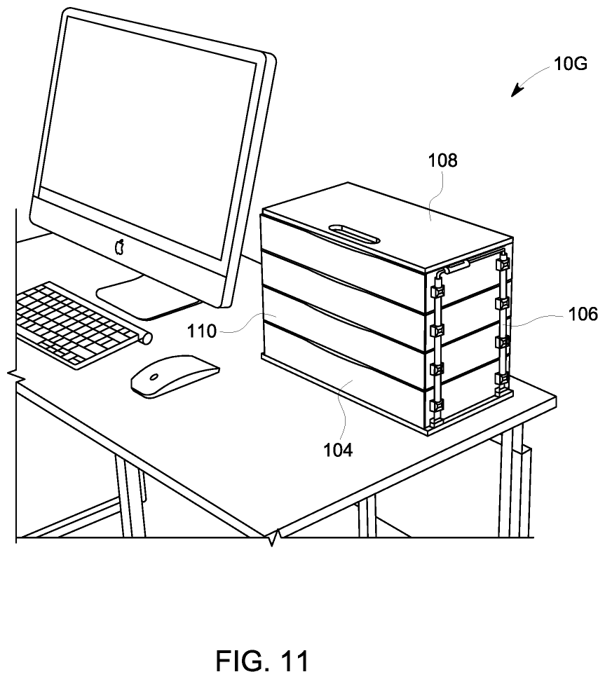

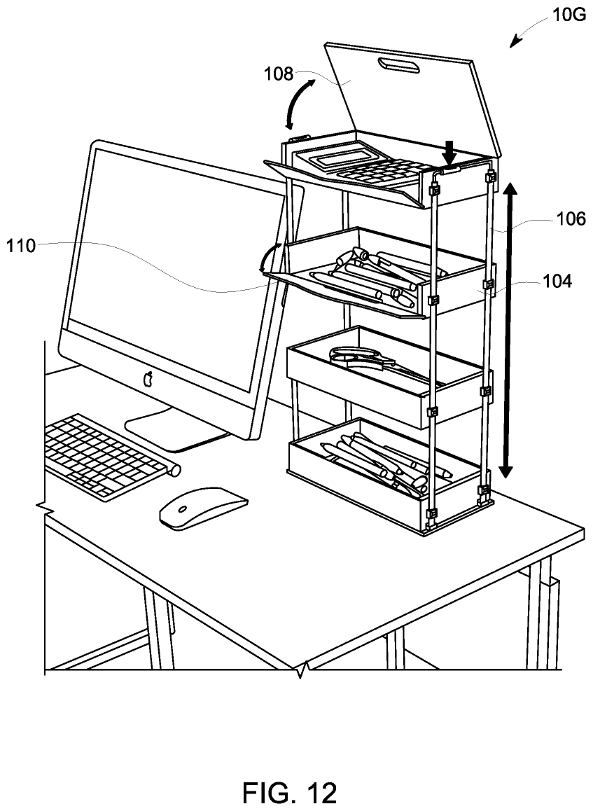

Referring to FIGS. 11 and 12, a collapsible storage system 10G may be deployed in a desktop environment. Of course, the system 10G may be used in any desired environment beyond that illustrated. The system 10G can include a plurality of compartments 104. In this case, four compartments 104 are illustrated. Telescoping arms 106 may be provided about the exterior of the compartments, permitting the compartments to move from a closed configuration (FIG. 11) to an open configuration (FIG. 12). Each compartment 104 may have an open top, where an upper one of the compartments 104 may include a top member 108. The top member 108, as discussed above, may be removable, hinged, sliding or the like, to provide access to the top one of the compartments 104. In some embodiments, a front cover 110 of one or more of the compartments 104 may be openable, such as hinged at the bottom (as shown) or side, for example. A release button can be provided to permit movement between the open and closed configurations. The telescoping members 106 may lock into the fully open and/or fully closed positions. Such locking can permit moving the system 10G around without inadvertent opening and also permit access to the inside of the compartments without the system inadvertently closing.

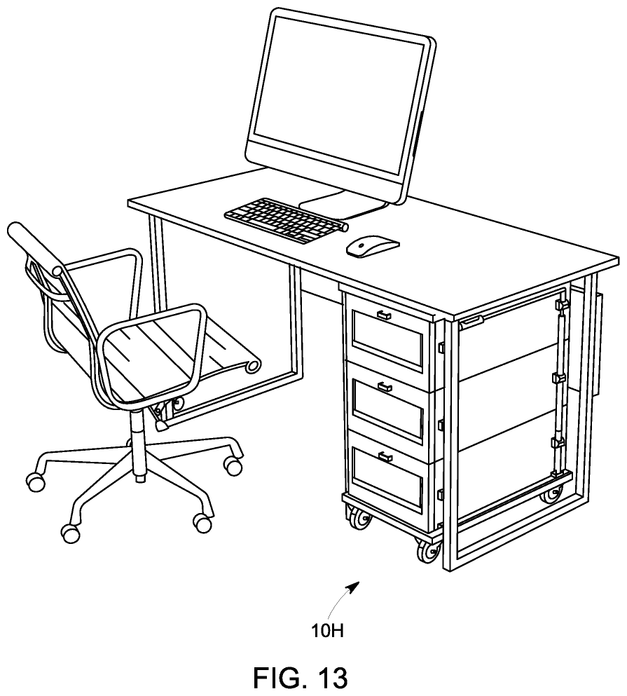

Referring to FIGS. 13 and 14, a collapsible storage system 10H may be deployed in an under desk or under table environment. Of course, the system 10H may be used in any desired environment beyond that illustrated. The system 10H can include a plurality of compartments 112. In this case, three compartments 112 are illustrated. Telescoping arms 114 may be provided about the exterior of the compartments, permitting the compartments to move from a closed configuration (FIG. 13) to an open configuration (FIG. 14). Each compartment 112 may have an open top, where an upper one of the compartments 112 may include a top member 118. The top member 118, as discussed above, may be removable, hinged, sliding or the like, to provide access to the top one of the compartments 112. In some embodiments, a front cover 120 of one or more of the compartments 112 may be openable, such as hinged at the bottom (as shown) or side, for example. A release button 116 can be provided to permit movement between the open and closed configurations. The telescoping members 114 may lock into the fully open and/or fully closed positions. Such locking can permit moving the system 10H around without inadvertent opening and also permit access to the inside of the compartments without the system inadvertently closing.

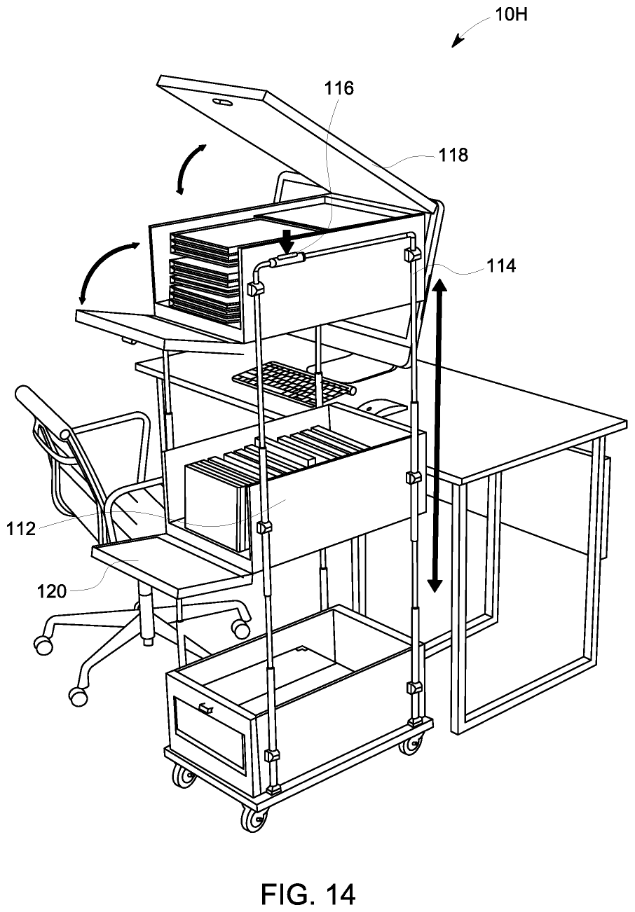

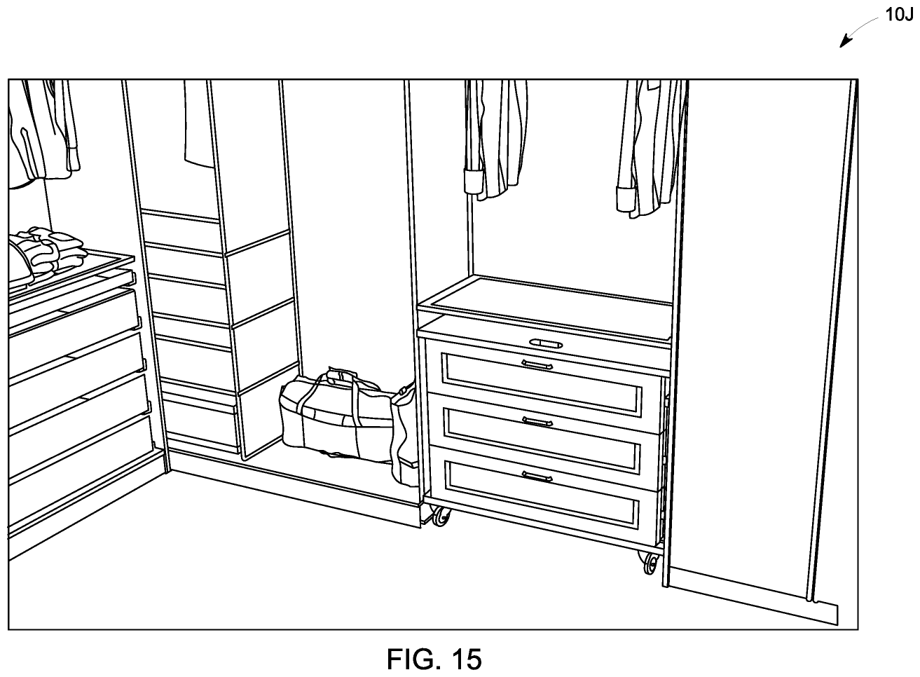

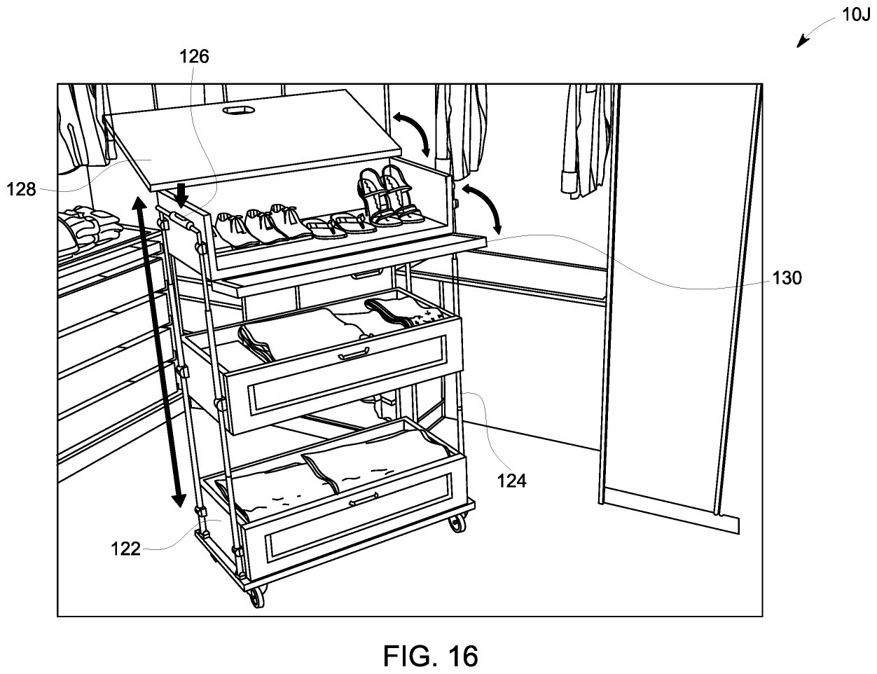

Referring to FIGS. 15 and 16, a collapsible storage system 10J may be deployed in a closet or other confined space environment. Of course, the system 10J may be used in any desired environment beyond that illustrated. The system 10J can include a plurality of compartments 122. In this case, three compartments 122 are illustrated. Telescoping arms 124 may be provided about the exterior of the compartments, permitting the compartments to move from a closed configuration (FIG. 15) to an open configuration (FIG. 16). Each compartment 122 may have an open top, where an upper one of the compartments 122 may include a top member 128. The top member 128, as discussed above, may be removable, hinged, sliding or the like, to provide access to the top one of the compartments 122. In some embodiments, a front cover 130 of one or more of the compartments 122 may be openable, such as hinged at the bottom (as shown) or side, for example. A release button 126 can be provided to permit movement between the open and closed configurations. The telescoping members 124 may lock into the fully open and/or fully closed positions. Such locking can permit moving the system 10J around without inadvertent opening and also permit access to the inside of the compartments without the system inadvertently closing.

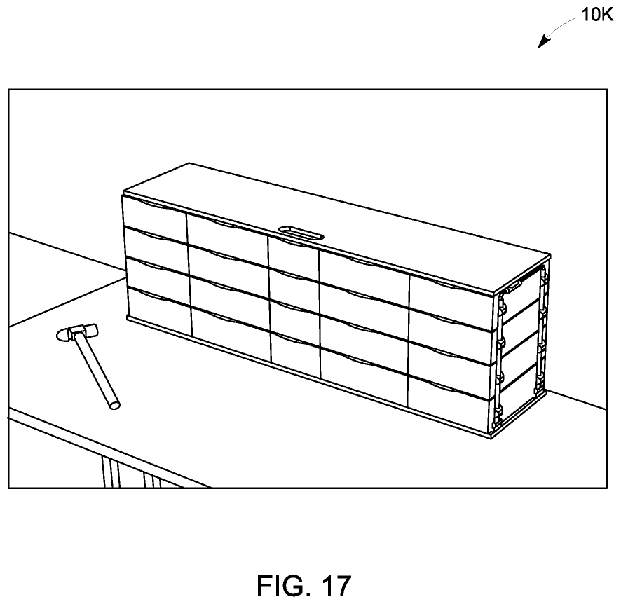

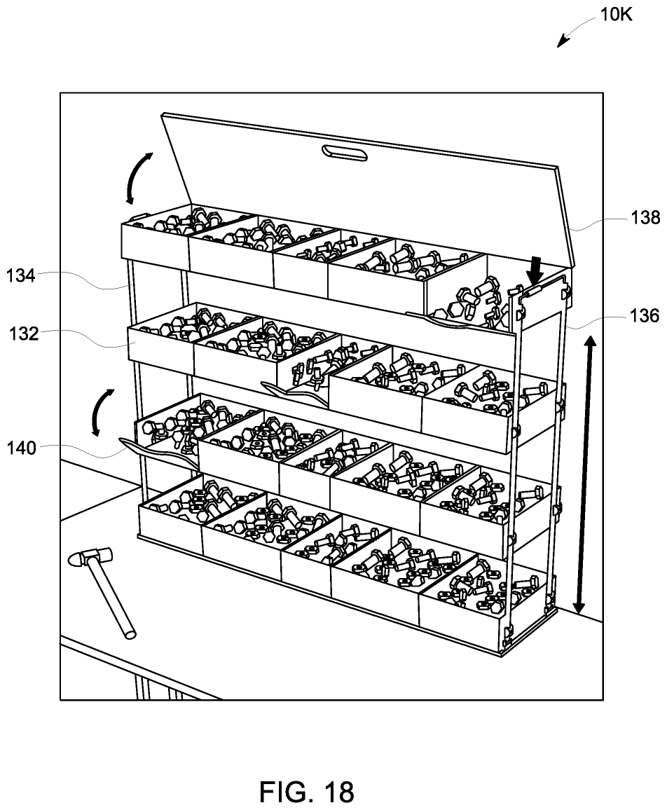

Referring to FIGS. 17 and 18, a collapsible storage system 10K may be deployed in a workshop environment. Of course, the system 10K may be used in any desired environment beyond that illustrated. The system 10K can include a plurality of compartments 132. In this case, four layers of compartments with each layer having multiple compartments 132, side-by-side, are illustrated. Telescoping arms 134 may be provided about the exterior of the compartments, permitting the compartments to move from a closed configuration (FIG. 17) to an open configuration (FIG. 18). Each compartment 132 may have an open top, where an upper one of the compartments 132 may include a top member 138. The top member 138, as discussed above, may be removable, hinged, sliding or the like, to provide access to the top one of the compartments 132. In some embodiments, a front cover 140 of one or more of the compartments 132 may be openable, such as hinged at the bottom (as shown) or side, for example. A release button 136 can be provided to permit movement between the open and closed configurations. The telescoping members 134 may lock into the fully open and/or fully closed positions. Such locking can permit moving the system 10K around without inadvertent opening and also permit access to the inside of the compartments without the system inadvertently closing.

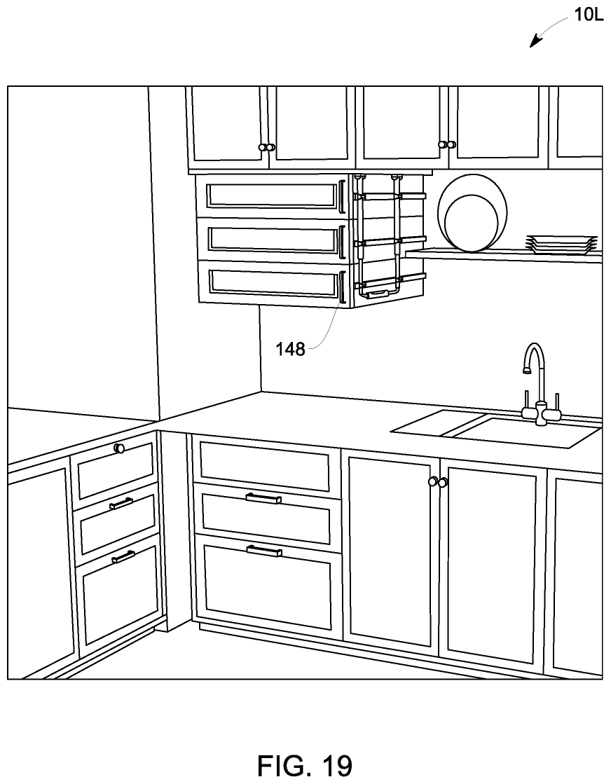

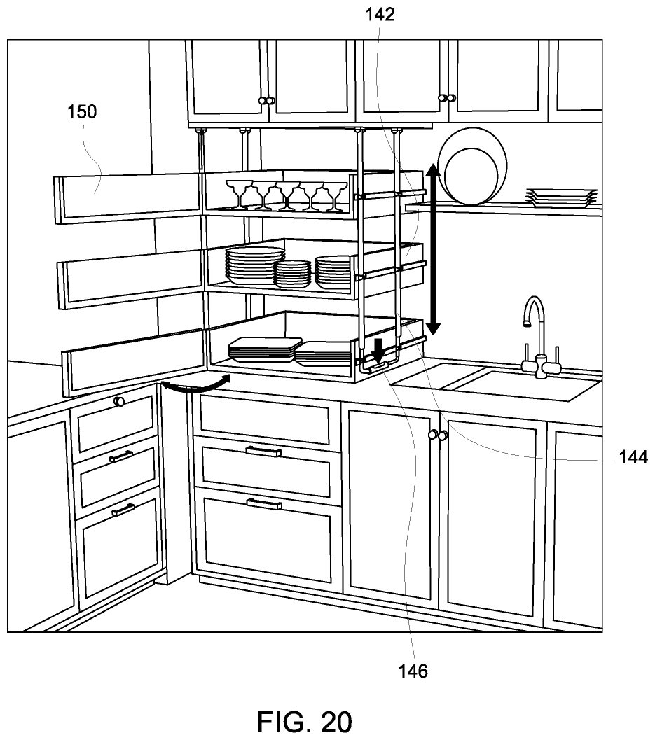

Referring to FIGS. 19 and 20, a collapsible storage system 10L may be deployed in an under cabinet or under other environments where the system can extend vertically downward when moving from the closed configuration to the open configuration. Of course, the system 10L may be used in any desired environment beyond that illustrated. The system 10L can include a plurality of compartments 142. In this case, three compartments 142 are illustrated. Telescoping arms 144 may be provided about the exterior of the compartments, permitting the compartments to move from a closed configuration (FIG. 19) to an open configuration (FIG. 20). Each compartment 142 may have an open top. In some embodiments, a front cover 150 of one or more of the compartments 142 may be openable, such as hinged at the bottom or hinged on the side, as shown, for example. A release button 146 can be provided to permit movement between the open and closed configurations. The telescoping members 144 may lock into the fully open and/or fully closed positions. Such locking can permit moving the system 10L around without inadvertent opening and also permit access to the inside of the compartments without the system inadvertently closing.

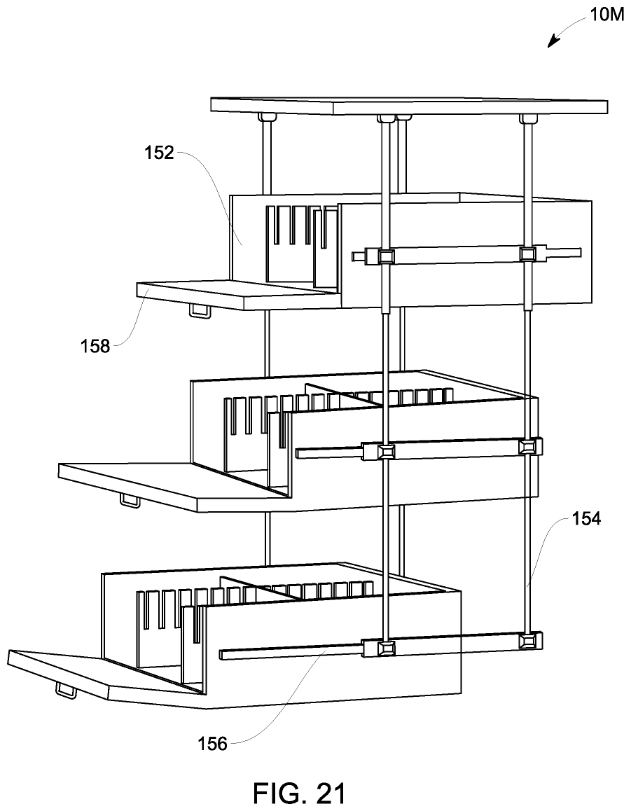

Referring to FIG. 21, a collapsible storage system 10M may be deployed in an under cabinet or under other environments where the system can extend vertically downward when moving from the closed configuration to the open configuration. Of course, the system 10M may be used in any desired environment beyond that illustrated. The system 10M can include a plurality of compartments 152. In this case, three compartments 152 are illustrated. Telescoping arms 154 may be provided about the exterior of the compartments, permitting the compartments to move from a closed configuration to an open configuration (FIG. 21). In some embodiments, a front cover 158 of one or more of the compartments 152 may be openable, such as hinged at the bottom or hinged at the side, as shown, for example. A release button can be provided to permit movement between the open and closed configurations. The telescoping members 154 may lock into the fully open and/or fully closed positions. Such locking can permit moving the system 10M around without inadvertent opening and also permit access to the inside of the compartments without the system inadvertently closing. A slide mechanism 156 can be provided to permit at least one of the compartments 152 to slide horizontally, similar to a sliding drawer, in a direction generally perpendicular to the direction of movement of the compartments between the open and closed configurations. The sliding feature may be operable either when the system 10M is only open or both when the system 10M is either open or closed.

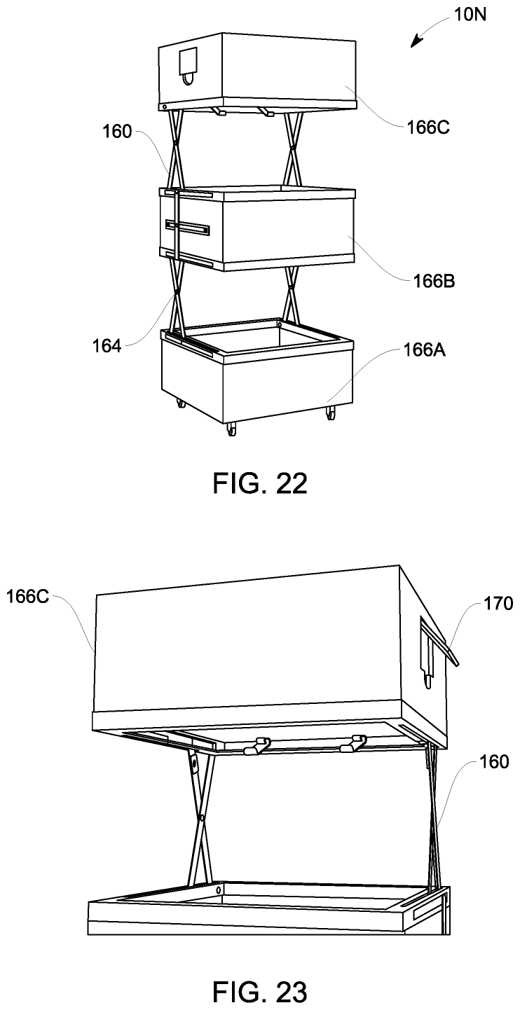

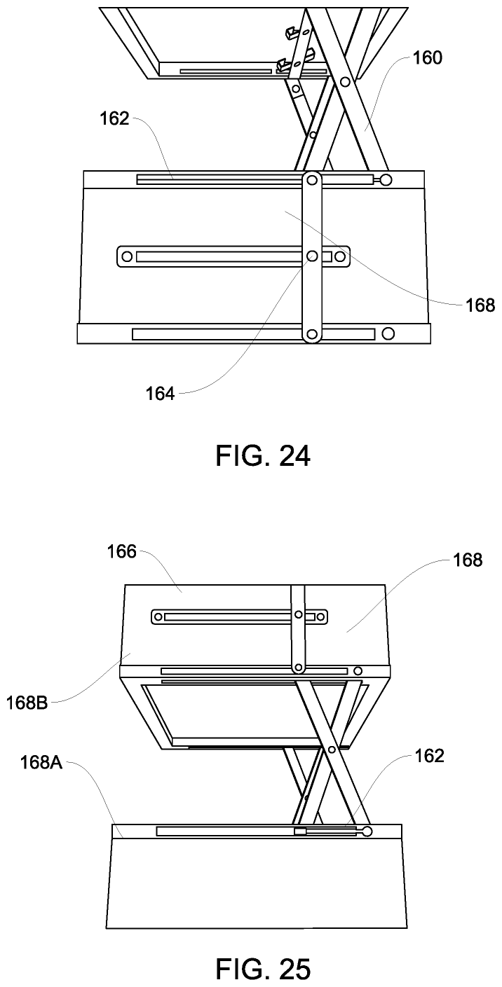

Referring now to FIGS. 22 through 25, a collapsible storage system 10N that can use a scissor mechanism 160 that interacts with channels 162 in each of the compartments 166. Within the channels 162, a spring, hydraulic cylinder, pneumatic cylinder, or the like, may be used to provide a biasing force to the scissor mechanism 160. Further, a middle one of the compartments 166 can include a central channel 164 having a connector slidable therein and attached to the scissor mechanisms 160 for both the upper and lower compartments 166. This causes separation of the compartments 166 to occur at the same rate and time during moving from the closed configuration to the open configuration. Like the above embodiments, a release button 170 can be provided to permit movement between the open and closed configurations.

It should be understood that, while wheels 32 are shown on some embodiments, such as in FIGS. 1 and 2, for example, the wheels may be included or omitted, depending on the specific application and/or portability desired by the user. Accordingly, where figures include wheels, such embodiments may omit the wheels and, similarly, where figures do not include wheels, wheels may be added for ease of movement of the collapsible storage system.

Further, while various elements may be described separately and for specific functions, in some embodiments the drawer slides, telescoping luggage handles, and drawer slides may be used together to add additional stability and fluidity.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A collapsible storage system comprising:
one or more compartments, each having a base, opposing sides rising from the base, a back member rising from the base and interconnecting the opposing sides at a back end thereof, a front member rising from the base and interconnecting the opposing sides at a front end thereof;
a lift mechanism for raising at least one of the one or more compartments away from a respective one of the plurality of compartments located immediately below, wherein
the collapsible storage system is movable between a closed configuration, having a first system height, and an open configuration, where access to the open top of each of the compartments is provided.

2. The collapsible storage system of claim 1, wherein at least one of the one or more compartments has an open top.

3. The collapsible storage system of claim 1, wherein the one or more compartments is a plurality of compartments.

4. The collapsible storage system of claim 1, wherein the lift mechanism includes a scissor lift mechanism.

5. The collapsible storage system of claim 1, wherein the lift mechanism includes a telescoping member.

6. The collapsible storage system of claim 1, wherein the lift mechanism includes at least one of a spring, a hydraulic cylinder and a pneumatic cylinder.

7. The collapsible storage system of claim 1, wherein the lift mechanism includes at least one of a linear actuator and a motor.

8. The collapsible storage system of claim 1, wherein the lift mechanism includes a scissor lift mechanism assisted by at least one of one or more springs, one or more hydraulic cylinders, one or more pneumatic cylinders, a motor and a linear actuator.

9. The collapsible storage system of claim 1, further comprising one or more telescoping braces extending along an outer surface of each of the one or more compartments.

10. The collapsible storage system of claim 1, further comprising an inside panel covering a portion of an open space formed between adjacent ones of the one or more compartments.

11. The collapsible storage system of claim 1, further comprising an outer wall covering an outer surface of the lift mechanism.

12. The collapsible storage system of claim 2, further comprising a top cover removably attached to cover the open top of an upper one of the one or more compartments.

13. The collapsible storage system of claim 1, wherein at least one front member of at least a selected one of the one or more compartments is openable to provide access into an interior of the selected one.

14. The collapsible storage system of claim 1, further comprising a base member supporting a lower one of the one or more compartments.

15. The collapsible storage system of claim 14, wherein the lower one of the one or more compartments is raised from the base member when the collapsible storage system is in the open configuration.

16. The collapsible storage system of claim 14, wherein the lower one of the one or more rests on the base member when the collapsible storage system is in the open configuration.

17. The collapsible storage system of claim 14, further comprising at least three wheels configured to support the base on a surface.

18. The collapsible storage system of claim 1, wherein the collapsible storage system is disposed on a base, the base being below a lowermost one of the one or more compartments and each of the one or more compartments move upward, relative to the base, when the collapsible storage system is moved from the closed configuration to the open configuration.

19. The collapsible storage system of claim 1, wherein a upper surface of the collapsible storage system is attached to a structure, the structure being above an uppermost one of the one or more compartments and each of the one or more compartments move downward, relative to the structure, when the collapsible storage system is moved from the closed configuration to the open configuration.

20. The collapsible storage system of claim 1, wherein at least one of the one or more compartments is slidable in a direction perpendicular to a direction of movement when the collapsible storage system moves from the closed configuration to the open configuration.

21. The collapsible storage system of claim 1, further comprising a release button, the release button permitting the lifting mechanism to move between the closed configuration and the open configuration.

22. The collapsible storage system of claim 21, wherein the collapsible storage system has a locking mechanism that locks into the closed configuration when the collapsible storage system is closed, and locks into the open configuration when the collapsible storage system is open, wherein the release button releases the locking mechanism to permit re-configuration of the collapsible storage system.

23. The collapsible storage system of claim 1, further comprising a slide mechanism operable to permit movement of at least one of the one or more compartments in a horizontal direction.
